(19) United States
(12) Patent Application Publication
(10) Pub. No.: US 2019/0137450 A1
(43) Pub. Date: May 9, 2019

(54) RESONANT ACOUSTIC GAS SENSOR

(71) Applicant: 3M INNOVATIVE PROPERTIES COMPANY, St. Paul, MN (US)

(72) Inventors: Stephen J. Willett, St. Paul, MN (US); Erik A. Aho, New Richmond, WI (US); Eric J. Alfuth, Minneapolis, MN (US); Benjamin P. Heppner, Minneapolis, MN (US); Richard L. Rylander, Stillwater, MN (US); Benjamin K. Stein, Lino Lakes, MN (US); Daniel A. Temple, Cedar Park, TX (US)

(21) Appl. No.: 16/074,121

(22) PCT Filed: Jan. 23, 2017
(86) PCT No.: PCT/US2017/014539

§ 371 Date: Jul. 31, 2018

Related U.S. Application Data
(60) Provisional application No. 62/289,537, filed on Feb. 1, 2016.

(51) Int. Cl. G01N 29/036; G01N 29/34; G01N 29/42

(52) U.S. Cl. CPC G01N 29/036; G01N 29/348; G01N 2291/021; G01N 2291/105; G01N 29/42

(57) ABSTRACT

Resonant acoustic gas sensors and methods for operating acoustic gas sensors that improve detection and reduce power consumption through the use of dynamic thresholds for identifying resonance peaks and optimizing searching for subsequent resonance peaks. The resonant acoustic gas sensors may use one or two separate transducers to produce the electronic signal that is filtered and used to identify the resonance peaks, using either voltage or impedance values to identify resonance peaks and use the resonance peaks to determine the composition of the gas mixture being measured.

### BACKGROUND

Detection of explosive gases is an essential safety component in the mining, oil and gas industries, and in commercial, residential and industrial settings powered by natural gas. As supplied by utility companies, natural gas is typically >95% methane, so practically all commercial detectors are designed to sense that compound and measure its concentration in air. Of particular concern is the explosive concentration range of 5-15%. Sensing technologies underlying those sensors include mid-infrared spectroscopy, thermal conductivity, resistance of thick film semiconductors, heat from catalyzed oxidation, and currents from flame ionization. Each of these sensors has limitations in concentration range covered, accuracy, selectivity, power required, ease of use, calibration, robustness, longevity and/or cost.

Some types of acoustic sensors are already used in the natural gas industry. Many of these are based on the noise made by high pressure gas as it exits a small orifice, and is especially useful in the production and transmission segments of the market, with pressures typically 200-1500 psi. However, distribution of natural gas to end users is at much lower pressures (as low as 0.25 psi), so that the sound of leaks would be undetectable above background noise. Also, the noise from high pressure leaks is non-selective to the species of gas emitted. Acoustic sensors compute the composition of a gas that includes the particular gas of interest based on the effect of the composition of the gas mixture on the behavior of sound waves. This may be done by measuring the time-of-flight of an acoustic signal or by measuring the frequencies where there is resonance, due to the change in speed of sound based on the composition of the fluid it is traveling through.

It is also desirable to maximize the power efficiency of sensors, due to the rise of distributed and remote sensing systems. In these systems, sensors may be placed at a location and only visited sporadically by maintenance personnel, and the locations may be far from access to electrical power sources. As a result, the sensors may need to run for long periods on battery power, or utilize limited power-harvesting capabilities. Improving the power efficiency of these sensors increases the amount of time they can be deployed or simplifies design requirements for devices incorporating these sensors in remote sensing or otherwise limited-power environments.

### SUMMARY OF THE INVENTION

System embodiments of the invention are acoustic sensors comprising a gas-permeable measurement chamber, a transmitter and a receiver located along or within the measurement chamber, a microcontroller driving an oscillator to drive the transmitter, and an integrating peak-detecting circuit processing the output of the receiver. The integrating peak-detecting circuit integrates the voltage response of the receiver. A dynamic threshold is used to determine where a peak exists with less susceptibility to noise while retaining sensitivity. In some embodiments, the system is configured to skip ahead in frequency space once a peak has been detected to more efficiently search for subsequent resonance peaks once the first has been determined, based on where a resonance peak would be expected in a reference gas, such as air. In some embodiments, the separate transmitter and receiver may be replaced by a single transducer, whose complex impedance is measured by an analog-to-digital converter.

Methods of the invention comprise measuring the response of a receiver to a frequency and determining whether that response is indicative of a resonance peak. If the response is not indicative of a resonance peak, the initial frequency is incremented by a coarse adjustment and the measurement is repeated. If the response is indicative of a resonance peak, a dynamic threshold is set and the frequencies producing a response above this threshold are captured, with the resonance peak determined to be at the midpoint between the lowest and highest frequencies producing results above the threshold. In some embodiments, the method may then proceed to find the next resonance peak by incrementing the determined resonance frequency by a constant value based on the distance between resonance frequency peaks in air, and using that incremented value as the initial frequency for a subsequent iteration of the method.

### BRIEF DESCRIPTION OF THE DRAWINGS

FIG. 1 is a diagram of an acoustic gas sensor with a separate transmitter and receiver.

FIG. 2 is a diagram of an acoustic gas sensor with a reference chamber as well as a test chamber.

FIG. 3 is a diagram of an acoustic gas sensor with one transducer.

FIG. 4 is the resonance peaks for a particular gas and the setting of a dynamic threshold for determining a resonance frequency from one of those peaks.

FIG. 5 is a circuit diagram of a portion of the electronics for the acoustic gas sensor.

FIG. 6 is a flow diagram for a method for operating an acoustic sensor to set dynamic thresholds and efficiently search for subsequent resonance peaks.

### DETAILED DESCRIPTION

Acoustic gas sensors typically measure the composition of a gas based on its effects on the speed of sound through that medium. The sensor may be calibrated to measure the concentration of a selected gas in a mixture, for example a concentration of methane in air.

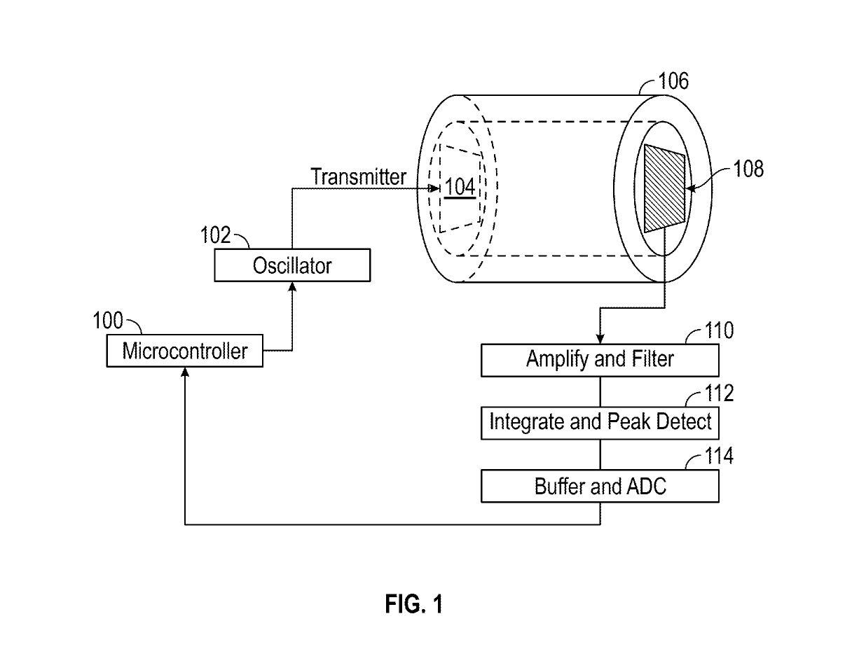

An example embodiment of an acoustic sensor featuring a separate transducer and receiver is depicted in FIG. 1. Microcontroller 100 drives oscillator 102 to produce a particular frequency at transmitter 104. The acoustic waves produced by transmitter 104 travel through measurement chamber 106 to reach receiver 108, which outputs a voltage signal that is amplified and filtered through a band-pass filter at 110 and run through an integrating and peak-detecting circuit 112. The integrating and peak-detecting circuit is connected to an analog-to-digital converter 114, which detects the analog signal at the integrating and peak detecting circuit 112 and converts the analog signal to a digital signal that is provided to the microcontroller 100.

Microcontroller 100 is configured to identify frequencies at which to drive oscillator 102 and to output those frequencies to the oscillator, and to interpret the digital signals input from analog-to-digital converter 114 and use those to determine the frequency at which to drive the oscillator, and to produce an output indicative of the concentration of the measured gas. The microcontroller 100 may be a standard processor that is programmed with instructions in memory to process these inputs and provide these outputs. The microcontroller 100 may be a commercially available chip such as a Microchip PIC16F1718-E/SO. Microcontroller 100 drives oscillator 102, which may be, for example a numerically controlled oscillator, or a voltage-to-frequency generator. The oscillator 102 generates waves, in some embodiments square waves, having a frequency based on an input value received from the microcontroller 100. These waves are used to drive transmitter 104. Microcontroller 100 also receives an input from analog-to-digital converter 114 and uses that input to determine resonance frequencies and to select the frequency at which to drive the oscillator 102 and to compute the concentration of the measured gas. The resonance frequencies output by the microcontroller 100 may be determined based on values stored in memory, or may be based on incrementing previous or stored values based on the presence or absence of a resonance peak or relationships among values that indicate that a frequency is or is not near a resonance peak. The microcontroller may determine the concentration of a measured gas by using the frequencies of the resonance peak or peaks or the difference in frequencies for successive resonance peaks, and optionally data from an environmental sensor or from a sealed reference chamber, to compare the resonance behavior observed in the measurement chamber 106 against the expected or measured resonance behavior of a reference gas composition, such as air.

The waves generated by the oscillator 102 drive transmitter 104, which is an acoustic transducer, to vibrate, producing sound waves at the supplied frequency. The transmitter 104 is located on, in, or near measurement chamber 106, directing the sound waves from the transmitter 104 to travel within the chamber 106. The measurement chamber 106 is a gas-permeable chamber which the gas mixture to be measured may enter. In some embodiments, the transmitter 104 and the receiver 106 are located at opposite ends of the measurement chamber 106. In some embodiments, the measurement chamber is cylindrical and the cylinder has a length greater than the diameter of either end. In other embodiments, the measurement chamber may have a rectangular or elliptical cross-section, and the length of the chamber may be less than the length or width of the cross-section. The chamber is preferably made of a rigid material, such as PVC or Nylon. The measurement chamber may be made gas permeable through holes, slits or other openings which allow gas to enter the chamber. In some embodiments, the openings in the measurement chamber are one or more lengthwise slits, running the length of the chamber to ensure consistent effects on the resonance of sound within the chamber. In some embodiments, the slits are thin to ensure the surface area of the slits is only 10% or less of the surface area of the inside of the chamber. These slits may be covered with a membrane material, which is gas-porous but prevents the entrance of solids or liquids into the chamber. An example membrane material is EPTFE. The measurement chamber may be attached to a housing containing the electronics, so that the measurement chamber is free-floating when a unit containing this sensor is mounted or placed to serve as a remote sensor, or to be part of a hand-held device including this sensor. For examples where the sensor is mounted, this may be done using adhesives or mechanical features of the housing such as hooks, slots, tabs, or holes for screws or bolts.

The sound in the chamber is measured by receiver 108, which is an acoustic transducer. The sound waves in the chamber cause the receiver 108 to produce a voltage, which is then passed through an amplifier and a band-pass filter 110. The output from the amplifier and band-pass filter 110 enters an integrating and peak-detecting circuit 112, which is configured to integrate the response to the provided frequency and compare the integrated value to a dynamic threshold. In one embodiment, the integrating peak detecting circuit uses an operational amplifier, and a capacitor in parallel with a resistor to perform the integration, and a transistor to discharge the capacitor following each measurement. In some embodiments, the transistor is a MOSFET, for example an Infineon IRLML2402TRPBF. The result of the integrating and peak-detecting circuit is then passed through an analog-to-digital converter 114 to produce a digital signal that is provided to microcontroller 100 for analysis. The analog-to-digital converter 114 may be included in the microcontroller 100, such as in the Microchip PIC16F1718-E/SO. The electronics, including but not limited to the microcontroller 100, transistor of integrating and peak detecting circuit 112, and analog-to-digital converter 114, may be powered by a battery for hand-held or remote sensing applications where the sensor is placed, mounted, or buried in a location for a period of time.

The concentration of the gas of interest that is computed at microcontroller 100 may be output to other devices, for example to a display to present to a user on a hand-held device, or to a communications link to transmit the concentration data to a network, or to another processor for use in additional operations, for example to trigger an audible alarm when the concentration of methane exceeds a pre-set threshold value.

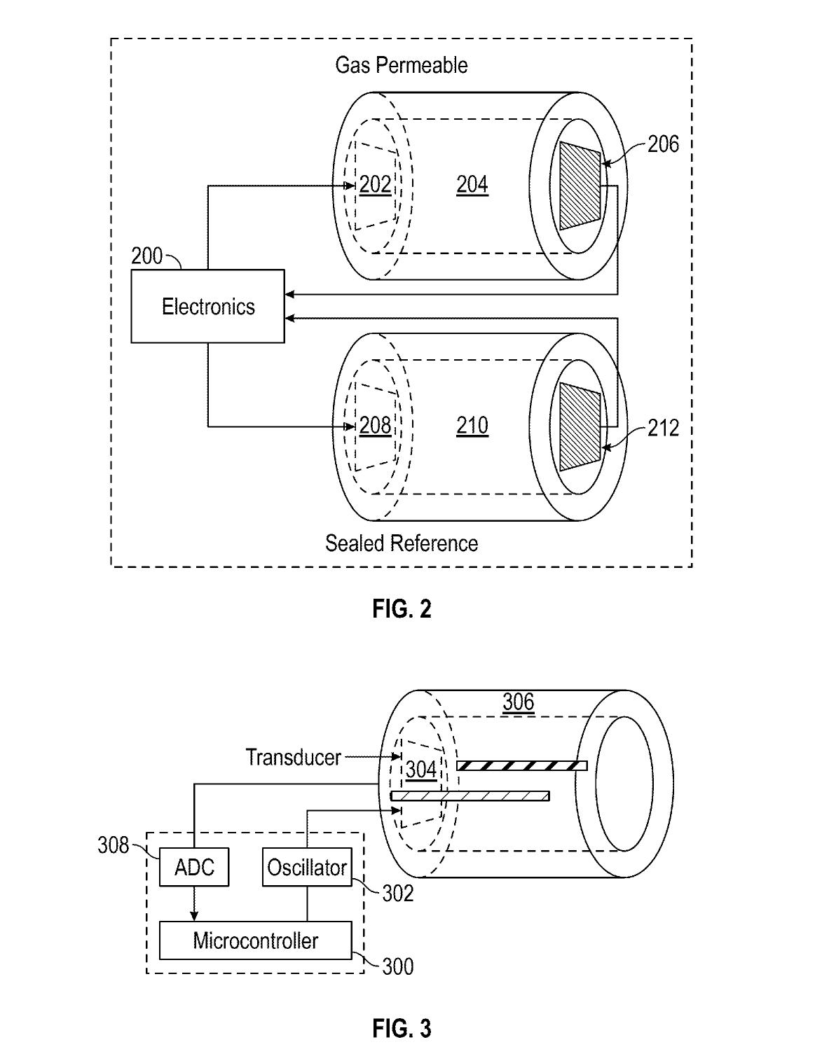

In some embodiments, a sealed reference chamber may be included in the sensor system. FIG. 2 is a diagram of an embodiment featuring a sealed reference chamber. In this example, the same electronics 200 are used to drive the transmitter for the measurement chamber 202 and the transmitter for the reference chamber 208 to evaluate the responses from the receiver 206 attached to test chamber 204 and from receiver 212 attached to reference chamber 210. The test chamber 204 is gas-permeable to allow the measured gas to enter that chamber along with air. The reference chamber 206 is sealed, so that it contains only a reference gas mixture, for example air, at the temperature at which the measurement is performed. Preferably, the reference chamber has the same shape and dimensions as the measurement chamber and is made of the same material. In some embodiments, the reference chamber is used to account for temperature differences in the behavior of measurement electronics and the properties of the gas mixtures, to allow comparisons between the mixture in the measurement chamber and a reference gas in a comparable state given the environmental conditions such as temperature and utilizing the same electronics. For the example embodiment depicted in FIG. 2 using both a transmitter and a receiver for each chamber, electronics 200 include the following elements depicted and described in FIG. 1 and the corresponding description: the microcontroller 100, the oscillator 102, the band-pass filter and amplifier 110, the integrating and peak detecting circuit 112, and the buffer and analog-to-digital converter 114. While the particular example of FIG. 2 uses voltage measurements and both a transmitter and receiver, the combination of a sealed reference chamber along with the gas-permeable measurement chamber may also be used with sensor setups that use only one transducer and which find resonance peaks based on the complex impedance across that transducer. In those embodiments with one transducer per chamber and using impedance measurements, the electronics which are used to evaluate both the reference and measurement chambers are described in FIG. 3.

In some embodiments, the environmental characteristics affecting the speed of sound in a gas mixture, such as humidity, pressure, and temperature, may be measured by sensors connected to the electronics, and provide data on those factors to allow the sensor readings to account for those effects when determining the level of gas, such as methane, in the gas mixture. These sensors may complement or replace a sealed reference chamber in some embodiments of the invention.

In some embodiments, an acoustic sensor may be made with only one transducer, as opposed to requiring at least two separate transducers where one functioning as the transmitter and the other as the receiver. In these embodiments, the complex impedance of the transducer is used to determine where there is a resonance peak; the complex impedance across the transducer peaks at resonance frequencies. The complex impedance may be measured by an analog-to-digital converter connected to the transducer.

An example of a single-transducer acoustic gas sensor is presented in FIG. 3. The microcontroller 300, for example a Microchip PIC16F1718-E/SO, drives an oscillator 302 which produces a signal of a particular frequency and wave type (for example, a square wave) which is provided to the transducer 304. The oscillator may be, for example, a numerically controlled oscillator (NCO) or a voltage-to-frequency generator. The transducer 304 is an acoustic transducer, which vibrates in response to the signal provided by the oscillator 302, producing sound in measurement chamber 306. At resonant frequencies, the sound in the chamber increases the impedance of the transducer 304. Measurement chamber 306 is gas-permeable to allow the air containing gas to be detected to enter the chamber. This gas permeability may be achieved by, for example, holes or a long slit in the tube to allow the sample gas to enter the chamber; these holes or slits may be covered with a gas-permeable membrane material such as EPTFE. An analog-to-digital converter 308 is used, measuring the complex impedance of the transducer 304 as the impedance changes with frequency the transmitter is operated at. The analog-to-digital converter may be included in microprocessor 300, such as in a Microchip PIC16F1718-E/SO. Optionally, a second transducer and a sealed reference chamber may also be operated using the same microcontroller 300, oscillator 302 and analog-to-digital converter 308 to measure a reference resonance, with the second chamber being sealed, and containing a reference gas, such as air.

In some embodiments, the composition of the measured gas may be computed from one resonance frequency using a calibrated function, instead of being based on the difference between the frequencies for two or more resonance peaks. The calibrated function may be specific to the geometry of the resonance cavity, the gas to be detected and the mixture the gas is detected in, and for a constrained range of temperatures and pressures and for a constrained range of possible resonance peak frequencies. The function may be a linear approximation of observed sensor responses to differing concentrations of the gas, within a bounded range of frequencies, or may, for example be computed from a physics model. For one particular example directed towards detecting methane in air at standard temperature and pressure, operating the transducer at frequencies between 3800 Hz and 4400 Hz, and using a cylindrical resonance chamber, the calibrated function is:

cₘ(%)=0.318*fₓ(Hz)−1243.

Where cₘ(%) is the concentration of methane by percentage of the gas mixture, and fₓ (Hz) is the frequency of the highest resonance peak in hertz.

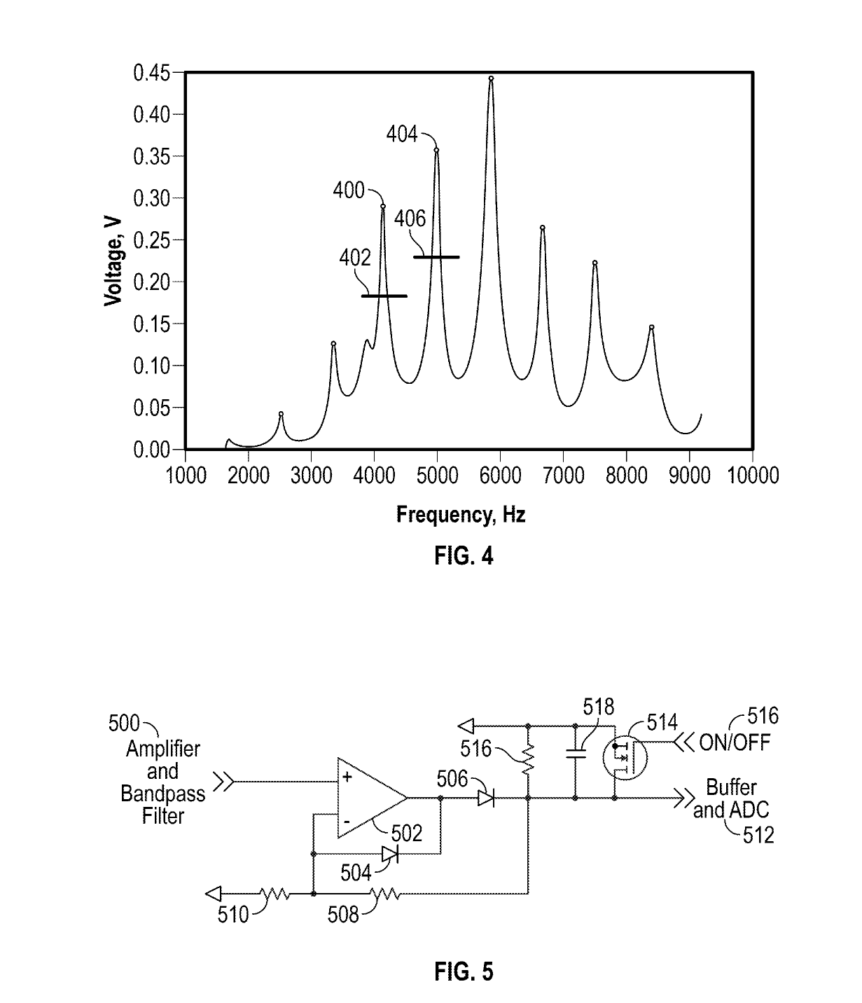

A dynamic threshold is used to identify the resonance peaks, to improve the accuracy and stability of the sensor by reducing the likelihood of a false positive for a peak resulting from noise in the sensor or electronics, without losing real resonance peaks below a fixed threshold. An example of the resonance peaks, along with a dynamic threshold for those peaks is presented in FIG. 4. In FIG. 4, the voltage output by the receiver is plotted against the frequency the transmitter is driven at. Resonance peaks 400 and 404 are representative of resonance peaks detected for the gas in the measurement chamber, and the distance between these resonance peaks as well as the positions of the resonance peaks provide information on the composition of the gas in the measurement chamber. Dynamic threshold 402 for resonance peak 400 and dynamic threshold 406 for resonance peak 404 represent the dynamic thresholds which are set as the sensor determines that it is nearing a resonance peak. These thresholds allow the resonance frequency for each peak to be found by taking the midpoint between the frequency at which the integrated response of the transducer first exceeds the threshold and the next frequency where the integrated response of the transducer falls below the threshold to identify the frequency producing the resonance peak.

An example circuit for performing the dynamic thresholding is diagrammed in FIG. 5. The circuit components themselves may be commonly available components of the listed types, arranged as presented in FIG. 5. This circuit may be used as the integrating and peak detecting circuit 112. In this example, the output of the bandpass filter in 110 enters the integrating and peak detecting circuit 112 at the non-inverting input 500 for operational amplifier 502. Operational amplifier 502 may be a commercially available op-amp such as a Texas Instruments TLV2464CDR. The inverting input of the operational amplifier 502 is connected to ground through resistor 510 (in this example, approximately 1 kΩ). The inverting input of op-amp 502 is also connected to the output of the operational amplifier 502 through diode 504. The output of the operational amplifier and diode 504 then pass through diode 506 which connects to resistor 516 (in this example, approximately 82 kΩ), capacitor 518 (in this example, approximately 0.1 μF), and MOSFET 514, which are in parallel and connected to ground. MOSFET 514 is controlled by an on/off signal 516 that is received from the microcontroller (100 in FIG. 1). MOSFET 514 is used to discharge the capacitor between measurements to ensure correct integration in each iteration of the measurements. MOSFET 514 may be a commercially available component such as an Infineon IRLML2402TRPBF. Other transistors could also be used in place of the MOSFET to discharge the integrating capacitor between measurements. The voltage at point 512 is passed along to the buffer and analog-to-digital converter (114 in FIG. 1) where the integrated signal is measured and converted to a digital signal that may be processed by the microcontroller (100 in FIG. 1) to determine the composition of the gas, for example the concentration of a selected gas in air.

In some embodiments, the search for resonance peaks is made more efficient based on the properties of the gas being sensed relative to air. For lighter-than-air gases such as methane, the distance in frequency space between resonance peaks in a mixture of air and that gas will be larger than a comparable measurement in air under similar conditions. Because of that, the frequencies between the current peak and the frequency at which the next resonant frequency could be expected in air will not contain the next resonance peak, and they do not need to be sampled. In some embodiments, these frequencies are skipped by incrementing the frequency by a constant D between peak detection cycles where a resonance peak has been identified, with D equaling the distance in frequency space between resonance peaks for air under similar environmental conditions.

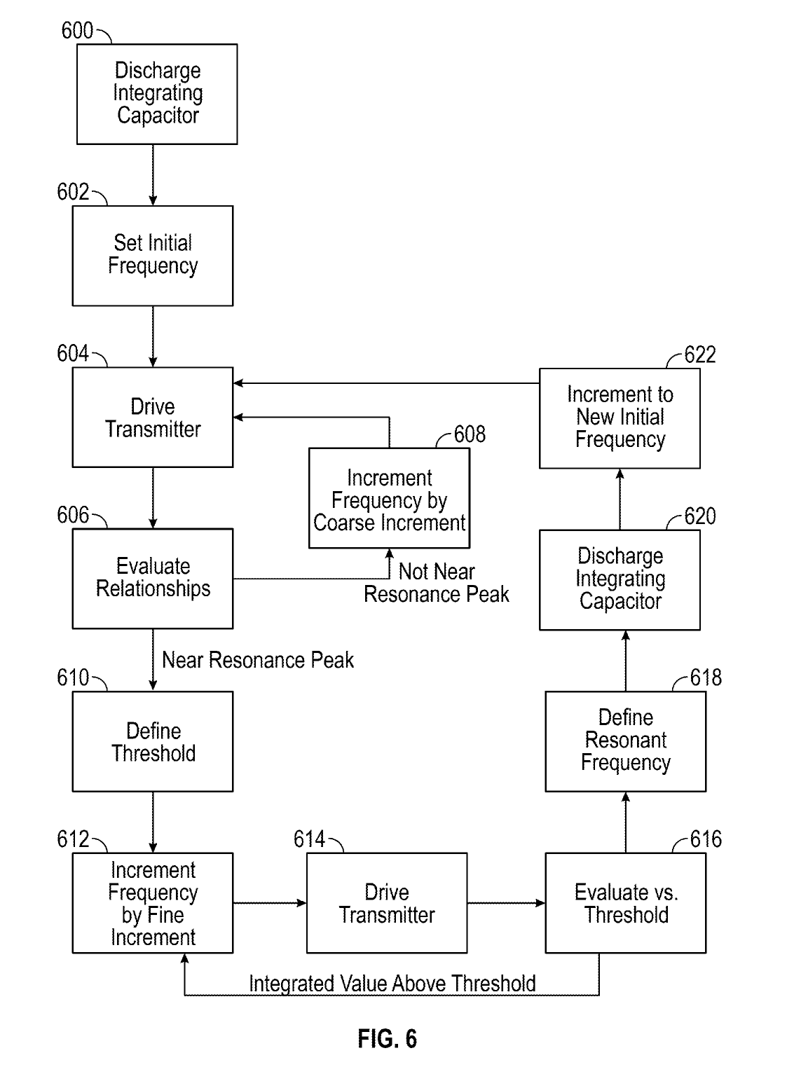

A flowchart of the method for operating the acoustic methane sensor to generate and use dynamic thresholds for resonance peaks, and optionally to skip portions of frequency space unlikely to include resonance peaks, is presented in FIG. 6. In this example, an integrating capacitor (for example, 518 in FIG. 5) is discharged in step 600, an initial frequency is set in step 602, the transmitter is driven with square waves of a frequency in step 604, and relationships among the response to the square waves are evaluated in step 606. Depending on the relationships observed, a new frequency may be selected by incrementing the current frequency by a coarse increment in step 608 and then once again driving the transmitter in step 604, or a threshold for resonance peaks may be defined in step 610 and the process continues. After step 610, the frequency is incremented by a fine increment in step 612, the transmitter is driven with square waves of the incremented frequency in step 614, and the results are evaluated in step 616. If in step 616 it is determined that the integrated value exceeds the threshold that was determined in step 610, the process iterates again by returning to step 612. If in step 616 the incremented frequency produces a value below the threshold, the process proceeds to step 618 where the resonant frequency is defined. In some embodiments, the process continues by discharging the integrating capacitor (for example, 518 in FIG. 5) again in step 620, then incrementing to a new initial frequency in step 622 to search for the next resonance peak following the detected resonance peak.

The integrating capacitor (for example, 518 in FIG. 5) is discharged in step 600 to clear the system and begin the resonance frequency determination process. The process itself begins by setting an initial frequency in step 602. The initial frequency may be set based on values stored in memory, or optionally based on the resonance values found in a reference chamber. Values stored in memory may be based on, for example, the range of frequencies the oscillator can produce and the transmitter can output, or frequencies where resonance peaks may be expected for a reference gas such as air. In some embodiments, there may be multiple initial frequencies stored in memory, from which one may be selected based on the environmental conditions, past measurements, or other information provided to the microcontroller.

The oscillator (for example, 102 in FIG. 1) is driven to produce a wave of the set frequency in step 604. The frequency may start at an initial frequency set in step 602 or an incremented frequency that results from the coarse incrementing step 608. Prior to each time the oscillator is driven, the system is cleared out, for example by turning on a transistor for a period of time to clear out an integrating capacitor, such as the MOSFET present at 514 in FIG. 5; in some embodiments, this MOSFET is turned on for 6 milliseconds in order to discharge the integrating capacitor. In some embodiments, the waves generated by the oscillator are square waves, and in some embodiments, those waves are generated for 5 ms. The waves are provided to an acoustic transducer which then produces sound waves based on the provided frequency, which then move through a chamber and are detected, optionally by a receiver or by measuring impedance across the transducer.

The measured response to the frequencies provided in step 604 is evaluated in step 606. If the relationships indicate that the current frequency range indicates that the range is not near a resonance peak, the frequency used for the next driving of the transmitter is incremented by a coarse increment in step 608. The coarse increment may be based on the expected width of resonance peaks, and sized to ensure that it will not jump past a resonance peak; this value may be set based on assumptions about the operation of the sensor such as the gas to be measured, the range of concentrations the gas may be measured over, and the expected ambient conditions for the sensor such as temperature and humidity. If the evaluation of step 606 indicates that the frequencies are approaching a resonance peak, the process continues to the threshold definition of step 610. The evaluation is based on the following inequality, which if true indicates that a resonance peak is near and the process should go to step 210, and if false, indicates that a resonance peak is not near and the process should go to step 608:

2a₂<a₅<a₆

And

a₄<a₅<a₆

Where a is the integrated value of the response to the frequencies over time, and the subscript is the particular point in time where the integral is taken to provide that value (in this example, the subscript is time in milliseconds).

The threshold is defined for finding the resonance peak in step 610. This threshold H may be set at the final value of a, the integrated value for the frequency that passed evaluation step 606. At this step, the frequency which passed step 606 may also be set as fᵢ, for subsequent use in determining the point of the resonance peak.

The frequency that passed the evaluation in step 606 and used to set the threshold in step 610 is then incremented by a fine increment in step 612. The fine increment is smaller than the coarse increment, and may be derived based on the expected width of resonance peaks in the gas mixtures to be measured, including the type of gas to be measured, the ambient conditions during the measurement, and the range of concentrations of interest for the gas to be measured. The transmitter is driven at the incremented frequency value for a given amount of time (in some embodiments, 5 ms) in step 614. As in step 604, sensing electronics may need to be cleared out, for example clearing the integrator by using a transistor to discharge the capacitor (for example, turning the transistor to “on” for 6 ms). The transistor used for this may, for example, be a MOSFET. The signal resulting from response to the sound generated by the transducer is integrated over time, and the integrated measurement compared to the threshold in evaluation step 616. In step 616, the integrated value is compared against the threshold to determine whether that value is above or below the threshold; this may be done simply by (aₓ-H), subtracting the threshold voltage value H from the voltage value aₓ that is integrated when the oscillator is driven at frequency x.

Once the integrated response to the frequency is again below the threshold the resonant frequency for the peak is defined in step 618. In one embodiment, the resonant frequency is defined by taking the midpoint between the initial, lowest frequency that yielded a result above the threshold value and the final, highest frequency that yielded a value above the threshold result, which may be done through the equation: fᵣ=(fᵢ+f_{f})/2, where fᵢ is the frequency that passed the evaluation in step 606 and f_{f} is the final frequency found in step 616 where the integrated value falls below the threshold. The resonance frequency may then be used to determine the difference between that resonance frequency and the expected resonance frequency in a reference gas, such as air, under the same conditions, from which the concentration of a gas may be derived.

In some embodiments, multiple peaks may be used in order to more accurately derive the concentration of a gas based on the difference in resonance frequencies between the measured gas and the expected or measured resonance frequencies for the reference gas. In these embodiments, when the gas to be sensed is lighter than air (and therefore the distance between the resonance peaks larger than would be in air), the process of finding the next peak may begin with discharging the integrating capacitor again in step 620. This step is the same as step 600. Once the integrating capacitor is discharged, a new initial frequency may be generated in step 622 by incrementing the resonance frequency defined in step 618 by a constant value D, where D is the distance between resonance peaks in the reference gas under the same conditions. In some embodiments, D is determined through measurements in a sealed reference chamber. In other embodiments, D may be stored in memory, or determined based on readings from environmental sensors such as temperature sensors. The incremented value is used to start a new iteration of the process by using the incremented new initial frequency in step 604 and looping through the process to step 618 where that next resonance peak is found.

1. An acoustic gas sensor, comprising:
a microcontroller,
a transmitter,
a gas-permeable measurement chamber,
a receiver,
a band-pass filter,
an integrating peak-detecting circuit, and
an analog-to-digital converter.

2. The acoustic gas sensor of claim 1, further comprising a numerically controlled oscillator.

3. The acoustic gas sensor of claim 2, wherein the microcontroller is configured to increment the initial frequency provided by the numerically controlled oscillator by a constant based on the distance between resonance peaks in air after each peak detection cycle.

4. The acoustic gas sensor of claim 1, further comprising:
a second transmitter,
a second receiver, and
a sealed reference chamber.

5. The acoustic gas sensor of claim 4, wherein the second receiver is connected to the same band-pass filter as the first receiver.

6. The acoustic gas sensor of claim 1, wherein the integrating peak-detecting circuit comprises:
an operational amplifier, the non-inverting input connected to the band-pass filter
a first diode between the inverting input of the operational amplifier and the output of the operational amplifier,
a second diode between the output of the operational amplifier and the analog-to-digital converter, and
a capacitor, a resistor and a transistor, each in parallel with one another between the second diode, the analog-to-digital converter, and ground.

7. The acoustic gas sensor of claim 6, wherein the transistor is a MOSFET.

8. The acoustic gas sensor of claim 1, further comprising a temperature sensor.

9. An acoustic gas sensor, comprising:
a microcontroller,
a transducer,
a frequency generator,
an analog-to-digital converter measuring the complex impedance across the transducer, and
a gas-permeable measurement chamber.

10. The acoustic gas sensor of claim 9, wherein the frequency generator is a numerically controlled oscillator.

11. The acoustic gas sensor of claim 9, wherein the microcontroller is configured to increment the initial frequency provided by the numerically controlled oscillator by a constant based on the distance between resonance peaks in air after each peak detection cycle.

12. The acoustic gas sensor of claim 9, further comprising:
a second transducer, and
a sealed reference chamber.

13. The acoustic gas sensor of claim 9, further comprising a temperature sensor.

14. A method for determining acoustic resonance frequencies in a gas, comprising: selecting an initial frequency,
driving a transmitter at the initial frequency,
determining whether the frequency is near a resonance peak,
incrementing the initial frequency by a coarse increment if not near a resonance peak,
defining a threshold if near a resonance peak,
incrementing the frequency by a fine increment if near a resonance peak,
driving the transmitter at the incremented frequency, and
determining a resonance frequency based on the frequencies where response was above the threshold.

15. The method of claim 14, further comprising:
setting a new initial frequency, equal to the initial frequency plus an offset value, wherein the offset value is based on the distance between resonance frequencies in pure air.

16. The method of claim 15, wherein the offset value is determined based on the resonance peaks discovered in a reference chamber connected to the acoustic sensor.

17.-19. (canceled)
